(19) United States
(12) Patent Application Publication
(10) Pub. No.: US 2019/0054835 A1
(43) Pub. Date: Feb. 21, 2019

(54) Charging Method of Electric Vehicle and Charging Station

(71) Applicant: Xmight Corporation Ltd., Taipei City (TW)

(72) Inventors: Yung-Chang LIANG, Taipei City (TW); Shu-Hui TIEN, Taipei City (TW); Kuo-Chuan WU, Taipei City (TW)

(21) Appl. No.: 16/102,798

(22) Filed: Aug. 14, 2018

(30) Foreign Application Priority Data
Aug. 17, 2017 (TW) 106127919

(51) Int. Cl. B60L 11/18; H04L 29/06; G06K 9/32; H04N 7/18

(52) U.S. Cl. CPC B60L 11/1846; H04L 63/08; H04L 63/123; G06K 2209/15; H04N 7/183; B60L 2230/16; G06K 9/3258

(57) ABSTRACT

A charging method of electric vehicle applied in charging station for electric vehicle, the method comprising: providing a control host, an authentication data acquisition device capable of communicating with the control host, and a charging apparatus at the charging station. When an electric vehicle is parked at the charging station, the authentication acquisition device is configured to capture an authentication data and transmit the authentication data to the control host. When the control host determines it's in off-line state with a remote server, the control host performs a specific calculation on an information to be verified included in the authentication data so as to obtain a value to be verified, and the control host allows the charging apparatus to output electric power to charge the electric vehicle parked at the charging station when the value to be verified is determined to be the same as a preset value.

### BACKGROUND OF INVENTION

### Field of the Invention

The present disclosure relates to a charging method, more particularly to a charging method of electric vehicle.

### Brief Description of Prior Art

In order to reduce air pollution caused by exhaust gas from vehicles using oil and gas, electric vehicles have been vigorously promoted and gradually used by an extensive range of consumers. Also, for the sake of obtaining electric power required for electric vehicles in public places, charging stations for electric vehicles have been setting up in public places to meet occasion demands. In order to save labor costs, the charging station usually allow consumers do the charging operation themselves. Therefore, in order to manage the charging station, the main research theme of the present disclosure is to ensure that the consumer is using the charging station under authorization.

### SUMMARY OF INVENTION

An object of the present disclosure is to provide a charging method of electric vehicle, whereby the authentication data related to charging an electric vehicle can be certified to determine whether to provide power for charging the electric vehicle or not.

Another object of the present disclosure is to provide a charging station for realizing the abovementioned method.

Therefore, the electric vehicle charging method of the present disclosure is applied to a charging station for electric vehicle, and the method includes the following steps: (A) providing a control host, an authentication data acquisition device capable of communicating with the control host and a charging apparatus at the charging station; (B) when an electric vehicle is parked at the charging station, the authentication data acquisition device is configured to capture an authentication data and provide the authentication data to the control host; and (C) when the control host determines it being in off-line state with a remote server, the control host performs a specific calculation on an information to be verified included in the authentication data so as to obtain a value to be verified, and the control host allows the charging apparatus to output electric power to charge the electric vehicle that has been electrically connected to the charging apparatus when the value to be verified is determined to be the same as a preset value.

In an embodiment, the authentication data acquisition device is configured to provide an input interface for manually inputting the authentication data. In another embodiment, the authentication data acquisition device includes an image scanning unit and a decoding unit. The authentication data is included in an encoded image and the encoded image is stored in an electronic carrier or printed on a physical object. The image scanning unit obtains the encoded image by scanning the electronic carrier or the physical object, and the decoding unit decodes the encoded image to obtain the authentication data.

In still another embodiment, the charging station is further provided with a network camera capable of communicating with the control host. The network camera is configured to capture an image frame of the charging station and transmit the image frame to the control host. The control host, when determining the value to be verified being the same as the preset value in step (C), further identifies the image frame to obtain a license plate number of the electric vehicle parked at the charging station. When the control host compares the license plate number is the same as one of the license plate numbers pre-stored in the control host, the charging apparatus is allowed to output power.

In yet another embodiment, when in step (C) the control host determining it being in connecting state with the remote server, the control host further performs step (D): the control host performs the specific calculation on the information to be verified included in the authentication data to obtain the value to be verified, and further transmit an identification information included in the authentication data to the remote server after determining that the value to be verified being the same as the preset value, so that the remote server, after determining the identity information being in accordance with a registered identity information pre-stored therein, sends back an authentication pass message to the control host, and the control host allows the charging apparatus to output electricity power after receiving the authentication pass message.

In still another embodiment, the charging station further includes a network camera capable of communicating with the control host, the network camera being configured to capture an image frame of the charging station and transmit the image frame to the control host; and in the step (D), the control host, after receiving the authentication pass message, further identifies the image frame to obtain a license plate number of the electric vehicle parked at the charging station. When the control host compares the license plate number is the same as one of the license plate numbers pre-stored in the control host, the charging apparatus is allowed to output power.

In yet another embodiment, the authentication data is a Base64 encoded data encrypted by RSA cryptosystem. In step (C), the control host decrypts the authentication data to obtain the Base64 encoded information to be verified.

Furthermore, the charging station for realizing the abovementioned method of the present disclosure can be connected to a remote server, the charging station comprises: a control host, an authentication data acquisition device capable of communicating with the control host, and a charging apparatus capable of communicating with the control host and the authentication data acquisition device, wherein the authentication data acquisition device is configured to capture an authentication data and provide the authentication data to the control host when the electric vehicle is parked at the charging station; when the control host determines it being in off-line state with the remote server, the control host performs a specific calculation on an information to be verified included in the authentication data to obtain a value to be verified; after the control host, determining the value to be verified being the same as a preset value, allows the charging apparatus to output power to charge the electric vehicle parked at the charging station and electrically connected to the charging apparatus.

The effect of the invention will be described as below: the control host provided at the charging station (local end) firstly determining whether it being in connecting state with the remote server or not, and then judging it being in off-line state with the remote server, the control host verifies whether the user has been authorized to use the charging apparatus of the charging station or not according to the authentication information provided by the user. Therefore, the local control host can determine whether to provide the power of the charging station to the electric vehicle without the authorization coming from the remote server.

### BRIEF DESCRIPTION OF THE ACCOMPANYING DRAWINGS

FIG. 1 is a process flowchart of an embodiment of electric vehicle charging method of the present disclosure;

FIG. 2 is a view showing the electronic device mainly included in an embodiment of a charging station of the present disclosure;

### DETAILED DESCRIPTION OF PREFERRED EMBODIMENTS

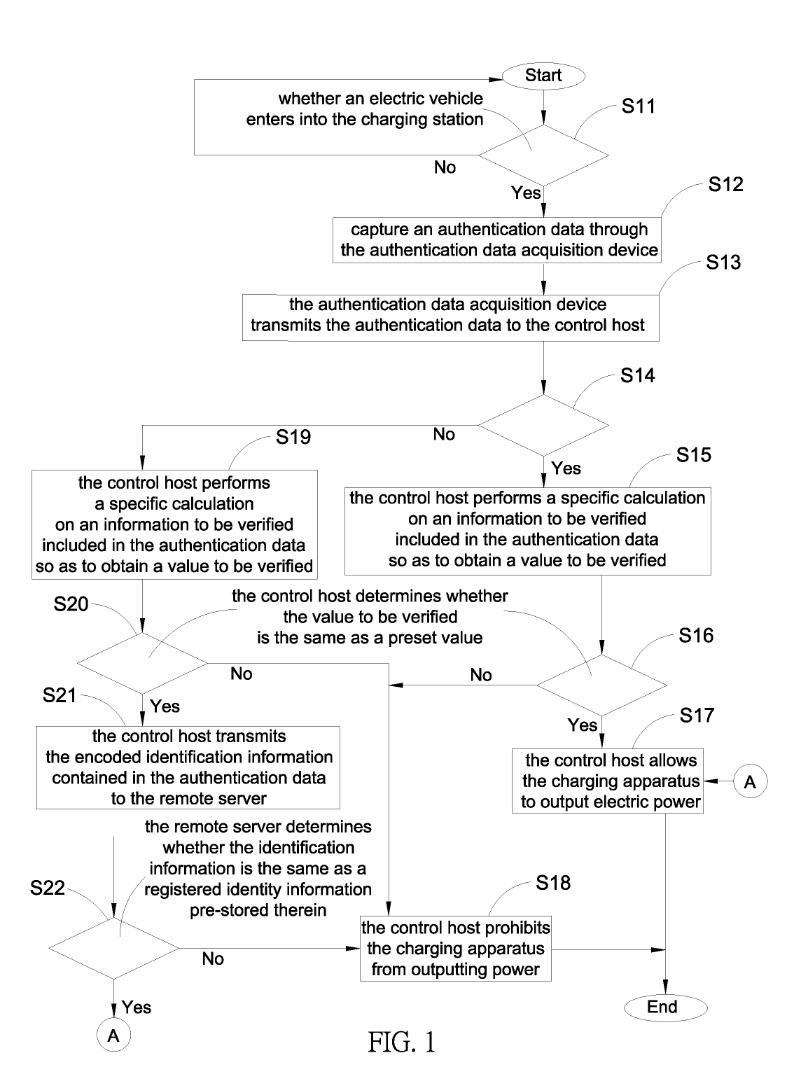

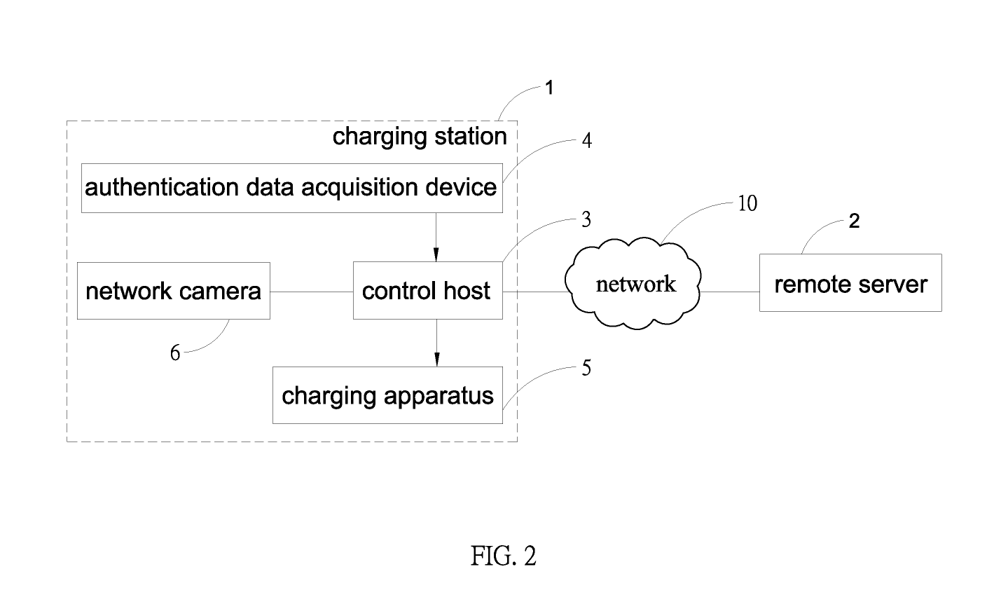

In FIG. 1, a process flowchart of an embodiment of electric vehicle charging method of the present disclosure is shown. The method is realized by an embodiment of a charging station of the present disclosure as shown in FIG. 2. The charging station 1 can be connected to a remote server 2 via a network 10 (not limited to a wired network or a wireless network), and mainly comprises a control host 3, an authentication data acquisition device 4 capable of communicating with the control host 3, and a charging apparatus 5 capable of communicating with the control host 3 as well as the authentication data acquisition device 4, wherein the charging apparatus 5 can provide charging operation for electric vehicle and is adjacent to the authentication data acquisition device 4. Of course, the charging station 1 can be provided with more than one charging apparatus 5, and each charging apparatus 5 or the plurality of charging apparatuses 5 share a neighboring authentication data acquisition device 4 for charging more electric vehicles simultaneously. However, for the convenience of description, present embodiment takes the charging station 1 with only one charging apparatus 5 and with one authentication data acquisition device 4 adjacent to the charging apparatus 5 as example.

The method of this embodiment is shown in step S11 of FIG. 1. Firstly, the charging station 1 determines whether an electric vehicle enters into the charging station 1 and parks at the charging apparatus 5 or not. The determination can be done, for example, by a network camera 6 providing at the charging station 1 and capable of communicating with the control host 3. The network camera 6 can be configured to provide an image frame of the charging station 1 to the control host 3, and the control host 3 determines, according to the image frame, whether an electric vehicle has entered into the charging station 1 and parked at the charging apparatus 5 or not. If yes, proceeding to step S12, the control host 3 controls the authentication data acquisition device 4 to issue a message by means of a display screen or a voice output device to notify the user of the electric vehicle to input an authentication data through the authentication data acquisition device 4. The above step S11 is not a necessary step, and may be omitted. That is, the authentication data acquisition device 4 is always in standby state until an user of electric vehicle inputs an authentication data through the authentication data acquisition device 4, thereby confirming that the user of the electric vehicle has a charging demand and the electric vehicle should have entered the charging station 1 and parked at the charging apparatus 5.

In this embodiment, the authentication data acquisition device 4 may include an input interface (such as a keyboard or a touch screen) for user to manually input the authentication data through the input interface. Alternatively, the authentication data can be included in an encoded image by two dimension barcode or quick response (QR) code encoding method, and the encoded image is stored on an electronic carrier (such as a mobile phone, a tablet, etc.) or printed on a physical object (such as a card). The authentication data acquisition device 4 further includes an image scanning unit and a decoding unit, the image scanning unit can obtain the encoded image by scanning the encoded image presented on the electronic carrier or the physical object, and the decoding of the encoded image is performed by the decoding unit so as to obtain the authentication data. Then, the authentication data acquisition device 4 transmits the authentication data to the control host 3 as depicted in step S13 of FIG. 1.

Next, as shown in step S14 of FIG. 1, after receiving the authentication data, the control host 3 firstly determines whether it is in off-line state with the remote server 2 or not. If yes, proceeding to step S15, the control host 3 performs a specific calculation on an information to be verified included in the authentication data so as to obtain a value to be verified. For example, the authentication data may include an information to be verified and an identification information that are encoded (e.g., encoded in Base64) and encrypted (e.g., encrypted with a public key using an RSA cryptosystem). For example, if the charging station 1 is disposed in the basement of a restaurant A, the information to be verified may include the name, address of the restaurant A and date, and the identification information may be, for example, the ID number of the tenant or the room card number (or the room number). Therefore, when the control host 3 receives the authentication data, it decrypts the authentication data (for example, decrypts with a private key by using the RSA cryptosystem) to obtain the encoded authentication data, and then extracts the encoded information to be verified and the identification information.

Then, when the control host 3 determines it being in off-line state with the remote server 2, the control host 3 itself performs a calculation operation on the encoded information to be verified, for example, performing a remainder (modulo) operation on the encoded information to be verified so as to obtain a remainder (that is, the abovementioned value to be verified). Then, step S16 is performed to determine whether the remainder is the same as a preset value that is originally set. If yes, proceeding to step S17, the control host 3 allows the charging apparatus 5 to output power to charge the electric vehicle parked at the charging station 1 and electrically connected with the charging apparatus 5. On the contrary, in step S16, if the control host 3 determines the remainder is different from the preset value originally set, then proceeding to step S18, the control host 3 prohibits the charging apparatus 5 from outputting power.

Therefore, if the authentication data is provided to a user of the electric vehicle by the restaurant A, the information to be verified should be able to pass the inspection of the control host 3. On the contrary, if the authentication data is not provided by the restaurant A, then it's impossible to pass the inspection of the control host 3.

In addition, in step S16, if the remainder being the same as the preset value originally set is determined, the control host 3 can further identifies the image frame according to the image frame transmitted from the network camera 6, so as to obtain a license plate number of the electric vehicle parked at the charging station 1, and the control host 3 will not perform step S17 to allow the charging apparatus 5 to output power unless the license plate number is the same as a license plate number pre-stored therein.

In step S14, if the control host 3 determines it is not in off-line state (i.e., in wired state) with the remote server 2, then step S19 is performed. As in step S15, the control host 3 performs the specific calculation on the information to be verified included in the authentication data to obtain the value to be verified and then proceeds to step S20 to determine whether the value to be verified is the same as the preset value or not. If not, then proceeding to step S18, the control host 3 prohibits the charging apparatus 5 from outputting power; and if yes, then proceeding to step S21, the control host 3 further transmits the encoded identification information contained in the authentication data to the remote server 2, and as shown in step S22, the remote server 2 further determines whether the identification information is the same as a registered identity information pre-stored therein or not. If yes, the remote server 2 returns an authentication message back to the control host 3, and after the control host 3 receives the authentication message, should the Step S17 is performed to allow the charging apparatus 5 to output electric power to charge the electric vehicle parked at the charging station 1 and electrically connected to the charging apparatus 5. Otherwise, proceeding to step S18, the control host 3 prohibits the charging apparatus 5 from outputting power.

Additionally in step S21, after receiving the authentication message, the control host 3 may further identify the image frame to obtain the license plate number of the electric vehicle according to the image frame transmitted from the network camera 6, and the control host 3 will not proceed to step S17 to allow the charging apparatus 5 to output power, unless the license plate number is the same as a license plate number pre-stored therein.

Furthermore, after the charging apparatus 5 has completed the charging operation for an electric vehicle, the control host 3 can also obtain a power consumption information of the electric vehicle from the charging apparatus 5, and can provide the power consumption information and the authentication data relevant to the electric vehicle to the remote server 2, so that the remote server 2 can use those information and data as a basis to charge the user of the electric vehicle for the power expense.

Based on foregoing, the present disclosure has reached the efficacy and goal described as below: the control host 3 provided at the local end (i.e., the charging station 1) determines whether it is connected to the remote server 2 and judges it is in off-line state with the remote server 2, then the control host 3 checks whether user has been authorized to use the charging apparatus 5 of the charging station 1 according to the authentication data provided by user of the electric vehicle, thereby the local control host 3 can decide whether to provide power of the charging station 1 to the electric vehicle without authorization of the remote server 2.

While the present invention has been described by preferred embodiments in conjunction with accompanying drawings, it should be understood that the embodiments and the drawings are merely for descriptive and illustrative purpose, not intended for restriction of the scope of the present invention. Equivalent variations and modifications performed by person skilled in the art without departing from the spirit and scope of the present invention should be considered to be still within the scope of the present invention.

1. A charging method of electric vehicle, which is applied in charging station for electric vehicle, comprising following steps:
(A) providing a control host, an authentication data acquisition device capable of communicating with said control host, and a charging apparatus at said charging station;
(B) when an electric vehicle is parked at said charging station, said authentication acquisition device is configured to capture an authentication data and transmit said authentication data to said control host; and
(C) when said control host determines it being in off-line state with a remote server, said control host performs a specific calculation on an information to be verified included in said authentication data so as to obtain a value to be verified, and said control host allows said charging apparatus to output electric power to charge said electric vehicle parked at said charging station and electrically connected to said charging apparatus when said value to be verified is determined to be the same as a preset value.

2. The charging method of electric vehicle of claim 1, wherein said authentication data acquisition device is configured to provide an input interface for manually inputting said authentication data.

3. The charging method of electric vehicle of claim 1, wherein said authentication data acquisition device includes an image scanning unit and a decoding unit, and said authentication data is included in an encoded image which is stored in an electronic carrier or printed on a physical object; said image scanning unit obtains said encoded image by scanning said electronic carrier or said physical object, and said decoding unit decodes said encoded image to obtain said authentication data.

4. The charging method of electric vehicle of claim 1, wherein said charging station is further provided with a network camera capable of communicating with said control host, said network camera being configured to capture an image frame of said charging station and transmit said image frame to said control host; said control host, when determining said value to be verified being the same as said preset value in step (C), further identifies said image frame to obtain a license plate number of said electric vehicle parked at the charging station; when said control host compares said license plate number is the same as one of the license plate numbers pre-stored in said control host, said charging apparatus is allowed to output power.

5. The charging method of electric vehicle of claim 2, wherein said charging station is further provided with a network camera capable of communicating with said control host, said network camera being configured to capture an image frame of said charging station and transmit said image frame to said control host; said control host, when determining said value to be verified being the same as said preset value in step (C), further identifies said image frame to obtain a license plate number of said electric vehicle parked at the charging station; when said control host compares said license plate number is the same as one of the license plate numbers pre-stored in said control host, said charging apparatus is allowed to output power.

6. The charging method of electric vehicle of claim 3, wherein said charging station is further provided with a network camera capable of communicating with said control host, said network camera being configured to capture an image frame of said charging station and transmit said image frame to said control host; said control host, when determining said value to be verified being the same as said preset value in step (C), further identifies said image frame to obtain a license plate number of said electric vehicle parked at the charging station; when said control host compares said license plate number is the same as one of the license plate numbers pre-stored in said control host, said charging apparatus is allowed to output power.

7. The charging method of electric vehicle of claim 1, wherein, when said control host in step (C) determining it being in a connecting state with said remote server, said control host further performs step (D): said control host performs said specific calculation on said information to be verified included in said authentication data to obtain said value to be verified, and transmit an identification information included in said authentication data to said remote server after determining said value to be verified being the same as said preset value; said remote server, after determining said identity information being in accordance with a registered identity information pre-stored therein, sends back an authentication pass message to said control host, and said control host allows said charging apparatus to output electricity power after receiving said authentication pass message.

8. The charging method of electric vehicle of claim 2, wherein, when said control host in step (C) determining it being in a connecting state with said remote server, said control host further performs step (D): said control host performs said specific calculation on said information to be verified included in said authentication data to obtain said value to be verified, and transmit an identification information included in said authentication data to said remote server after determining said value to be verified being the same as said preset value; said remote server, after determining said identity information being in accordance with a registered identity information pre-stored therein, sends back an authentication pass message to said control host, and said control host allows said charging apparatus to output electricity power after receiving said authentication pass message.

9. The charging method of electric vehicle of claim 3, wherein, when said control host in step (C) determining it being in a connecting state with said remote server, said control host further performs step (D): said control host performs said specific calculation on said information to be verified included in said authentication data to obtain said value to be verified, and transmit an identification information included in said authentication data to said remote server after determining said value to be verified being the same as said preset value; said remote server, after determining said identity information being in accordance with a registered identity information pre-stored therein, sends back an authentication pass message to said control host, and said control host allows said charging apparatus to output electricity power after receiving said authentication pass message.

10. The charging method of electric vehicle of claim 7, wherein said charging station further includes a network camera capable of communicating with said control host, said network camera being configured to capture an image frame of said charging station and transmits said image frame to said control host; and in the step (D), said control host, after receiving said authentication pass message, further identifies said image frame to obtain a license plate number of said electric vehicle parked at said charging station; when said control host compares the license plate number is the same as one of the license plate numbers pre-stored in said control host, said charging apparatus is allowed to output power.

11. The charging method of electric vehicle of claim 8, wherein said charging station further includes a network camera capable of communicating with said control host, said network camera being configured to capture an image frame of said charging station and transmits said image frame to said control host; and in the step (D), said control host, after receiving said authentication pass message, further identifies said image frame to obtain a license plate number of said electric vehicle parked at said charging station; when said control host compares the license plate number is the same as one of the license plate numbers pre-stored in said control host, said charging apparatus is allowed to output power.

12. The charging method of electric vehicle of claim 9, wherein said charging station further includes a network camera capable of communicating with said control host, said network camera being configured to capture an image frame of said charging station and transmits said image frame to said control host; and in the step (D), said control host, after receiving said authentication pass message, further identifies said image frame to obtain a license plate number of said electric vehicle parked at said charging station; when said control host compares the license plate number is the same as one of the license plate numbers pre-stored in said control host, said charging apparatus is allowed to output power.

13. The charging method of electric vehicle of claim 1, wherein said authentication data is a Base64 encoded data encrypted by RSA cryptosystem; in step (C), said control host decrypts said authentication data to obtain said information to be verified which is Base64 encoded.

14. A charging station capable of connecting to a remote server, comprising:
a control host;
an authentication data acquisition device capable of communicating with said control host; and
a charging apparatus capable of communicating with the control host and the authentication data acquisition device;
wherein, said authentication data acquisition device is configured to capture an authentication data and provide said authentication data to said control host when an electric vehicle is parked at said charging station; when said control host determines it being in off-line state with said remote server, said control host performs a specific calculation on an information to be verified included in said authentication data to obtain a value to be verified; and said control host, after determining said value to be verified being the same as a preset value, allows said charging apparatus to output power to charge said electric vehicle parked at said charging station and electrically connected to said charging apparatus.

15. The charging station of claim 14, wherein said authentication data acquisition device provides an input interface for manually inputting said authentication data.

16. The charging station of claim 14, wherein said authentication data acquisition device further includes an image scanning unit and a decoding unit, and said authentication data is included in an encoded image which is stored in an electronic carrier or printed on a physical object; said image scanning unit obtains said encoded image by scanning said electronic carrier or said physical object, and said decoding unit decodes said encoded image to obtain said authentication data.

17. The charging station of claim 14, wherein said charging station is further provided with a network camera capable of communicating with said control host, said network camera being configured to capture an image frame of said charging station and transmit said image frame to said control host; said control host, when determining said value to be verified being the same as said preset value, further identifies said image frame to obtain a license plate number of said electric vehicle parked at the charging station; when said control host compares said license plate number is the same as one of the license plate numbers pre-stored in said control host, said charging apparatus is allowed to output power.

18. The charging station of claim 15, wherein said charging station is further provided with a network camera capable of communicating with said control host, said network camera being configured to capture an image frame of said charging station and transmit said image frame to said control host; said control host, when determining said value to be verified being the same as said preset value, further identifies said image frame to obtain a license plate number of said electric vehicle parked at the charging station; when said control host compares said license plate number is the same as one of the license plate numbers pre-stored in said control host, said charging apparatus is allowed to output power.

19. The charging station of claim 14, wherein, when said control host determining it being in a connecting state with said remote server, said control host performs said specific calculation on said information to be verified included in said authentication data to obtain said value to be verified, and transmits an identification information included in said authentication data to said remote server after determining said value to be verified being the same as said preset value; said remote server, after determining said identity information being in accordance with a registered identity information pre-stored therein, sends back an authentication pass message to said control host, and said control host allows said charging apparatus to output electricity power after receiving said authentication pass message.

20. The charging station of claim 15, wherein, when said control host determining it being in a connecting state with said remote server, said control host performs said specific calculation on said information to be verified included in said authentication data to obtain said value to be verified, and transmits an identification information included in said authentication data to said remote server after determining said value to be verified being the same as said preset value; said remote server, after determining said identity information being in accordance with a registered identity information pre-stored therein, sends back an authentication pass message to said control host, and said control host allows said charging apparatus to output electricity power after receiving said authentication pass message.

21. The charging station of claim 19, wherein said charging station further includes a network camera capable of communicating with said control host, said network camera being configured to capture an image frame of said charging station and transmits said image frame to said control host; said control host, after receiving said authentication pass message, further identifies said image frame to obtain a license plate number of said electric vehicle parked at said charging station; when said control host compares the license plate number is the same as one of the license plate numbers pre-stored in said control host, said charging apparatus is allowed to output power.

22. The charging station of claim 20, wherein said charging station further includes a network camera capable of communicating with said control host, said network camera being configured to capture an image frame of said charging station and transmits said image frame to said control host; said control host, after receiving said authentication pass message, further identifies said image frame to obtain a license plate number of said electric vehicle parked at said charging station; when said control host compares the license plate number is the same as one of the license plate numbers pre-stored in said control host, said charging apparatus is allowed to output power.
